(19) United States
(12) Patent Application Publication
(10) Pub. No.: US 2016/0032951 A1
(43) Pub. Date: Feb. 4, 2016

(54) A LOCK FOR A TELESCOPIC SUPPORT ELEMENT

(71) Applicant: ANSIK INC., Woodbridge (CA)

(72) Inventors: Nitish PAHWA, Mississauga (CA); Shiva BHARDWAJ, Woodbridge (CA)

(21) Appl. No.: 14/777,063

(22) PCT Filed: Mar. 12, 2014
(86) PCT No.: PCT/CA2014/050221

§ 371 Date: Sep. 15, 2015

Related U.S. Application Data
(60) Provisional application No. 61/849,837, filed on Mar. 15, 2013.

(51) Int. Cl. F16B 2/18; F16M 11/26; F16B 7/14; F16B 7/10

(52) U.S. Cl. CPC F16B 2/18; F16B 7/105; F16M 11/26; F16B 7/14

(57) ABSTRACT

The disclosure is directed at a lock for a telescopic support element including a housing including a central passageway for receiving the telescopic support element; a first cam mounted inside the housing adjacent the passageway; and a second cam mounted inside the housing adjacent the passageway opposite the first cam; wherein movement of the telescopic support element from a contracted position to an extended position within the central passageway causes the first cam and the second cam to rotate from an unlocked position to a locked position thereby locking the telescopic support element in place.

### CROSS REFERENCE TO RELATED APPLICATIONS

This application claims the benefit of U.S. Provisional Patent Application No. 61/849,837 filed Mar. 15, 2013, which is hereby incorporated by reference.

### FIELD

The present disclosure relates generally to locks. More particularly, the present disclosure relates to a lock for a telescopic support element.

### BACKGROUND

In certain circumstances, a door to a compartment may need to be kept open to allow continued access to that compartment. Such a case may be, for example, when the hood on a car needs to be kept open to allow access to the engine compartment, or when the hatch to an attic needs to be kept open to allow access to the attic. Where the door is oriented such that it is acted on by gravity, or some other force, a support may be provided to keep the door opened.

A support in such circumstances may use a fixed support element or a telescopic support element. A telescopic support element will typically provide greater ease of use than a fixed support element. Where a telescopic support element is used, the telescopic support element will generally need to be locked in position in order to provide continued access to the compartment.

Typical implementations of locks for a telescopic support element may require additional actions by a user to tighten a fastener of the lock to secure the telescopic support element. This manual tightening will generally be detrimental to the ease of use provided by the telescopic support element and may be dangerous if not securely tightened. Other typical implementations may use a strut-type telescopic support element which may include features for resisting longitudinal compression. However, the resistive longitudinal compression features may lose their functionality to support the door over time, thus becoming problematic and possibly dangerous.

### SUMMARY

It is an object of the present disclosure to obviate or mitigate at least one disadvantage of previous locks for a telescopic support element.

In a first aspect, the present disclosure provides a lock for a telescopic support element including a housing including a central passageway for receiving the telescopic support element; a first cam mounted inside the housing adjacent the passageway; and a second cam mounted inside the housing adjacent the passageway opposite the first cam; wherein movement of the telescopic support element from a contracted position to an extended position within the central passageway causes the first cam and the second cam to rotate from an unlocked position to a locked position thereby locking the telescopic support element in place.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1A illustrates a perspective front view of a lock in a closed position.

FIG. 1B illustrates a perspective rear view of the lock of FIG. 1A.

FIG. 1C illustrates a top view of the lock of FIG. 1A.

FIG. 1D illustrates a front view of the lock of FIG. 1A in an open position.

FIG. 2 is a flowchart illustrating a method of operating a lock for a telescopic support element.

FIG. 3A illustrates a schematic front view of a lock in an unlocked position.

FIG. 3B illustrates a schematic front view of the lock of FIG. 3A in a first intermediate position.

FIG. 3C illustrates a schematic front view of a lock of FIG. 3A in a locked position.

FIG. 3D illustrates a schematic front view of the lock of FIG. 3A in a second intermediate position.

FIG. 4 is a block diagram showing forces experienced by a lock.

FIG. 5A illustrates a perspective view of a locking mechanism for a according to a further embodiment.

FIG. 5B illustrates a perspective view of a cam for use with the locking mechanism of FIG. 5A.

FIG. 6A illustrates a front view of another embodiment of a locking mechanism in an unlocked position.

FIG. 6B illustrates a front view of the locking mechanism of FIG. 6A in a first intermediate position.

FIG. 6C illustrates a front view of the locking mechanism of FIG. 6A in a second intermediate position.

FIG. 6D illustrates a front view of the locking mechanism of FIG. 6A in a locked position.

### DETAILED DESCRIPTION

Generally, the present disclosure provides a lock for a telescopic support element and a method of manufacturing thereof. In one embodiment, the disclosure is directed at a locking apparatus for locks a telescopic support element in place by way of eccentrically-shaped cams.

In typical use, a telescopic support element will typically include two or more sections. Each section, except the outermost section, will generally have at least a portion that has a smaller circumferential dimension than the next larger section. This allows for inner sections with smaller circumferential dimensions to, at least partially, fit concentrically into the next largest section (called the outer section). Thus, the telescopic support element can have a contracted position in which all the inner sections, except the outermost section, are situated substantially flush with their respective outer section. Each inner section will also have a larger portion that stops the inner section from being completely removed from their respective outer section. Hence, the telescopic support element may have an extended position in which the sections are extended but for their larger portion of the inner sections abutting their respective outer sections.

In one example, the lock may be provided for a car hood telescopic support element to keep the hood open when access to the engine compartment is desired. In some cases, the telescopic support element may be a strut that is designed to resist longitudinal compression. With either a simple telescopic support element, or with a strut support element, the lock of the disclosure provides an apparatus for the hood be secured in place so that it does not close on a user while they are examining the engine compartment. In a preferred embodiment, the lock of the disclosure also does not require manual tightening by a user to lock the telescopic support element. Accordingly, the lock of the disclosure also reduces the likelihood that the telescopic support element may slip out of place or enhances the ease of use of the telescopic support element or both.

In use, the disclosure may be used in various applications in which locking of a telescopic support element is required, for example, a hatch to an attic, a manhole cover, a lid to a box, moveable furniture, exercise equipment, a jack, a hoist, and the like.

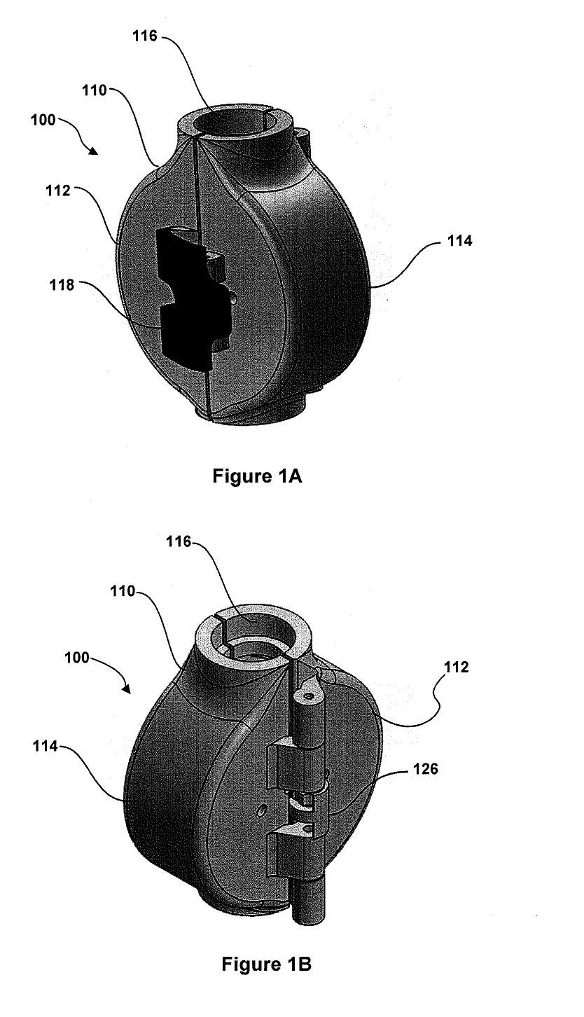

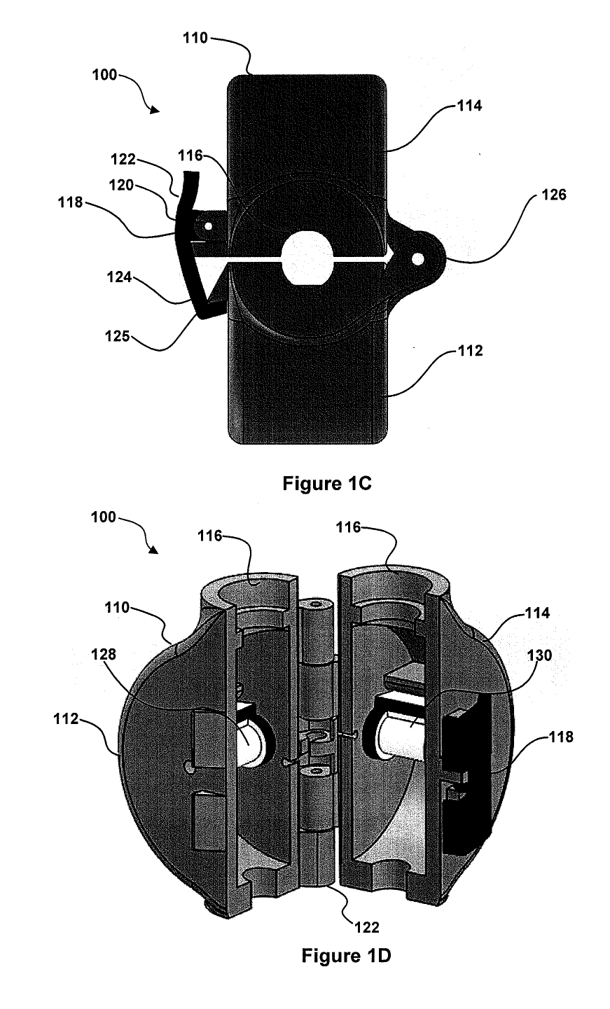

Turning to FIG. 1A, a perspective front view of a locking apparatus 100 for a telescopic support element is shown. As will be understood, the descriptors “front”, rear”, “back”, “top” and “bottom” are being used to provide positional references.

In FIG. 1A, the lock 100 is shown in a closed position. As shown, the lock 100 includes a housing 110 made up of a first portion 112 and a second portion 114. A central passageway 116 is located along a central vertical axis of the housing 110 and is configured to receive a portion of the telescopic support element (not shown) to pass through the lock 100. The front side of the lock 100 includes a fastener 118 for holding the front-side of the first portion 112 and the second portion 114 in the closed position. As illustrated in FIG. 1A, the fastener 118 may be implemented using a latch, however, other methods of fastening the first 112 and second 114 portions are contemplated, such as, but not limited to, a clasp, a clip, a button, a tie, a buckle, a pin, a strap, a buckle, and the like.

Turning to FIG. 1B, a perspective rear view of the lock 100 of FIG. 1A is shown. In a preferred embodiment, the first 112 and second 114 portions are joined together in a pivoting relationship such as a pivot point 126. When the fastener 118 (such as shown in FIG. 1D) is disengaged, the pivot point 126 allows the first portion 112 and second portion 114 to be moved away from each other from the closed position to an open position preferably with the assistance of a user.

While in the open position, the lock 100 may be able to receive the telescopic support element into the central passageway 116.

Turning to FIG. 1C, a top view of a lock 100 for a telescopic support element is shown. In FIG. 1C, the fastener may be seen in a more detail. The fastener 118, seen as the latch, includes a hinge 120, an engagement portion 112 and a catch portion 124. When the latch 118 is engaged (and the lock 100 is in the closed position), the catch portion 124 hooks onto an abutment 125 of the first portion 112. To disengage, the engagement portion 122 is depressed, causing the latch to rotate about the hinge 120 and the catch portion 124 to separate or be released from the abutment 125 of the first portion 112.

Turning to FIG. 1D, a perspective front view of the lock, in an opened position, is shown. While in the open position, the lock 100 is able to receive the telescopic support element (not shown) into its central passageway 116. After the telescopic support element is received into the central passageway 116, the lock may be closed whereby the first portion 112 and the second portion 114 can be brought into contact on the front-side of the lock 110 such that the fastener 118 can be engaged to secure the lock 100 around the telescopic support element.

In a further embodiment, the lock 100 can be integrally formed or manufactured with the telescopic support element. In such a case, the front-side and back-side of the first portion 112 and the second portion 114 can be permanently joined or fastened together such that the pivot point 126 and the fastener 118 may not be required.

As further shown in FIG. 1, the lock 100 includes a locking mechanism 127 which preferably includes a first cam 128 mounted inside the first portion 112 and a second cam 130 mounted inside the second portion 114. Both the first cam 128 and the second cam 130 (collectively “cams”) are mounted adjacent the central passageway 116 such that the first cam 128 and the second cam 130 are in contact with the telescopic support element when the lock 100 is in the closed position. This will be described in more detail below. In some cases, the portion of the cams that are in contact with the telescopic support element may be made of, or coated with, a material having a high-coefficient of friction; for example, rubber, sandpaper, resins, metal coating, sintered friction materials, and the like.

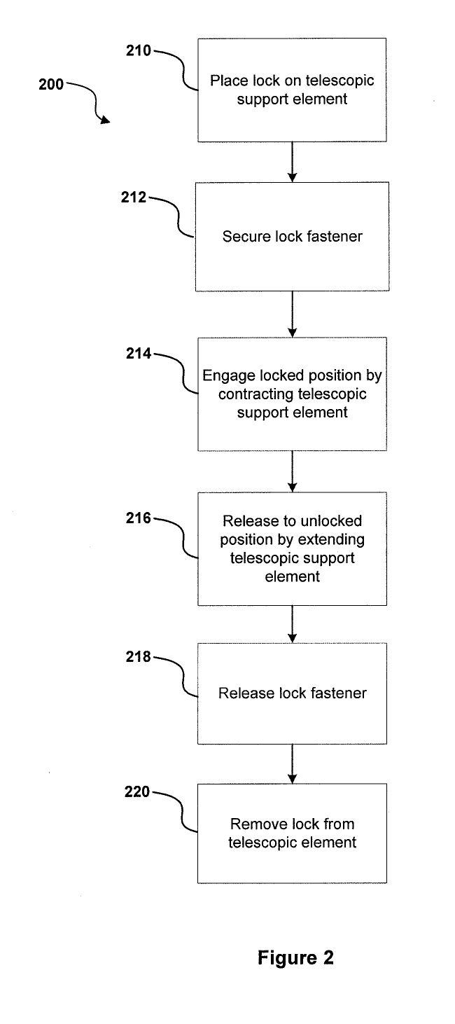

Turning to FIG. 2, a flowchart illustrating a method 200 of operating a lock for a telescopic support element, according to an embodiment, is shown. It is assumed that the lock is in the open position and able to receive a telescopic support element.

At 210, the lock 110 is placed around a portion of the telescopic support element and then the lock is closed and secured around the telescopic support element 212.

In one embodiment, prior to the lock being placed around the telescopic support element, the telescopic support element is preferably extended from a first position to a second position whereby an inner section of the telescopic support element is pulled out from an outer section. The lock may then be placed around an exposed portion of the inner section of the telescopic support element. In cases where the telescopic support element has three or more sections, the lock 110 is preferably placed around an exposed inner section with the smallest circumferential dimension.

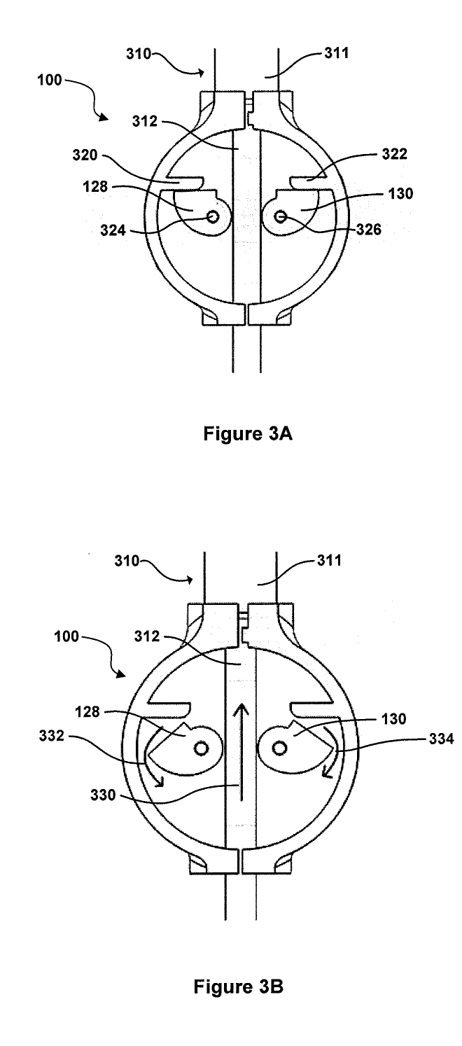

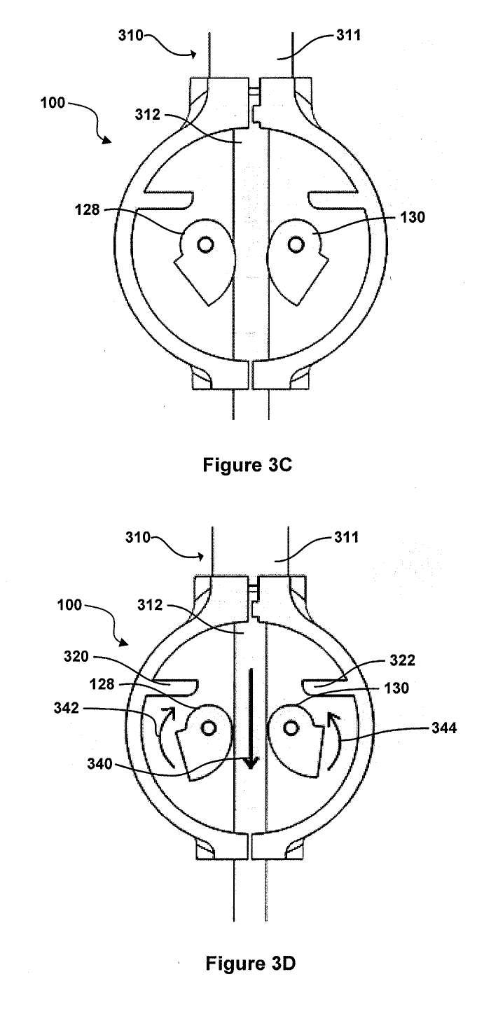

At 212, the fastener 118 is secured such that the lock 110 is in the closed position and secured in place around the telescopic support element. As shown in FIG. 3A, a top portion of the lock receives an outer (and larger) section 311 of the support element 310 while the central passageway 116 receives an inner section 312 of the support element 310.

As shown in FIG. 3A, the first cam 128 and the second cam 130 are in the unlocked position whereby the first cam 128 abuts a first stopper 320 and the second cam 130 abuts a second stopper 322 and a portion a portion of the cams 128,130 are in contact with the inner section 312 of the telescopic support element. The first cam 128 is mounted such that it rotates about its own pivot point 324 and the second cam 326 is mounted such that it rotates about its own pivot point 326. As is understood, FIG. 3A shows the inside of the lock after it has been closed around the support element 310.

In use, the frictional force supplied by the contact between the locking mechanism 127 (seen as cams 128,130) and the inner section 312 of the telescopic support element 310 is configured such that the force is great enough that upward travel of the inner section 312 causes rotation of the cams 128,130; however, the force should not be so great to cause substantial restraint for the inner section 312 when moving in the downward direction.

Turning to FIG. 3B, the locking mechanism is shown in a first intermediate position. The first intermediate position may be seen as a position between the unlocked position and a locked position. Due to gravity, the inner section 312 tends to contract inside the outer section 310 by moving in the direction denoted by arrow 330. As this movement occurs, the cams 128,130 rotate about the respective pivot points due to friction force between the cams 128 and 130 and the inner section 312. The first cam 128 rotates in the counter-clockwise direction denoted by arrow 332 and the second cam 130 rotates in the clockwise direction denoted by arrow 334.

As shown in FIGS. 3A and 3B, the cams 128,130 have an eccentric shape that is designed such that movement of the inner section 312 in the contracted direction 330 gradually causes radially larger portions of the cams 128,130 to come into contact with the inner section 312. Thus, as the cams 128,130 rotate, the normal forces (pinching forces) are increased, which cause greater forces of friction to be experienced between the cams 128,130 and the inner section 312. The relationship between the normal forces and the forces of friction are governed by the equation: F_{of Friction}=μF_{of Normal}; where μ is the coefficient of friction at the points of contact between the cams 128,130 and the inner section 312.

As the telescopic support element continues to contract in the direction of arrow 330, the locking mechanism will eventually be engaged in a locked position 214 thereby locking the telescopic support element 310 in place. This is schematically shown in FIG. 3C.

When the user is done and wishes to close the hood, or the item supported by the telescopic support element, the lock 100 may be released 216. In one embodiment, this may be completed by extending the inner section 312 relative to the outer section 311. A second intermediate position between the locked position and the unlocked position is illustrated in FIG. 3D. The inner section 312 moves in the direction denoted by arrow 340 and begins to extend out of the outer section 311. As this movement occurs, the cams 128,130 rotate due to friction whereby the first cam 128 rotates in the clockwise direction denoted by arrow 342 and the second cam 130 rotates in the counter-clockwise direction denoted by arrow 344 about their respective pivot points. Due to the eccentric shape of the cams 128,130, the normal forces on the inner section 312 are gradually decreased as the cams 128,130 rotate. The decreased normal forces permit the inner section 312 to travel in direction 340 without substantial restraint. As the inner section 312 is extended, the first cam 128 and the second cam 130 rotate until they abut their respective stoppers 320 and 322 respectively. As illustrated in FIG. 3A, when the cams 128,130 abut the stoppers 320,322, the locking mechanism is seen as being in the unlocked position.

At 218, the fastener 118 is released such that the front-side of the first portion 112 and the second portion 114 are no longer in contact and whereby the lock may be seen as being in the open position. At 220, the lock 110 is removed from contact with the telescopic support element.

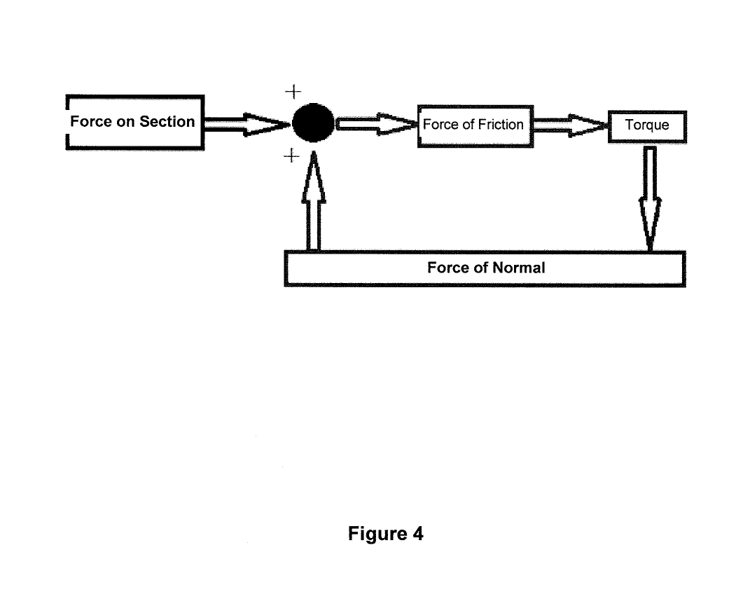

Turning to FIG. 4, a block diagram showing forces experienced by the lock is shown. On a diagrammatic level, the lock 100 of the disclosure can be viewed as a feedback loop in which the force of friction is used to act on itself. The rotation of the cams 128,130 is caused by the force acting on the inner section 312 which, through the force of friction, produces a torque on the cams 128,130. In response, this torque causes a normal force against the inner section 312 which ultimately increases the force of friction between the two surfaces due to the eccentric shape of the cams 128,130. The eccentrically shaped cams 128,130 produce increased forces due to the increasing radiuses that push on the inner section 312 with an equal and opposite reaction. Depending on the coefficients of friction amongst the contact materials of the cams 128,130 and the inner section 312, the applied force and the yield tensile strength of the materials, the load that can be supported by the lock 100 can be quantitatively determined.

In further embodiments, the lock 100 may include more than two cams oriented radially around the central passageway 116. In some cases where there are more than two cams the housing 110 may have more than two portions. In a further case, the lock 100 may only have one cam which, when in the locked position, is configured to pin the inner section 312 against a side of the central passageway 116.

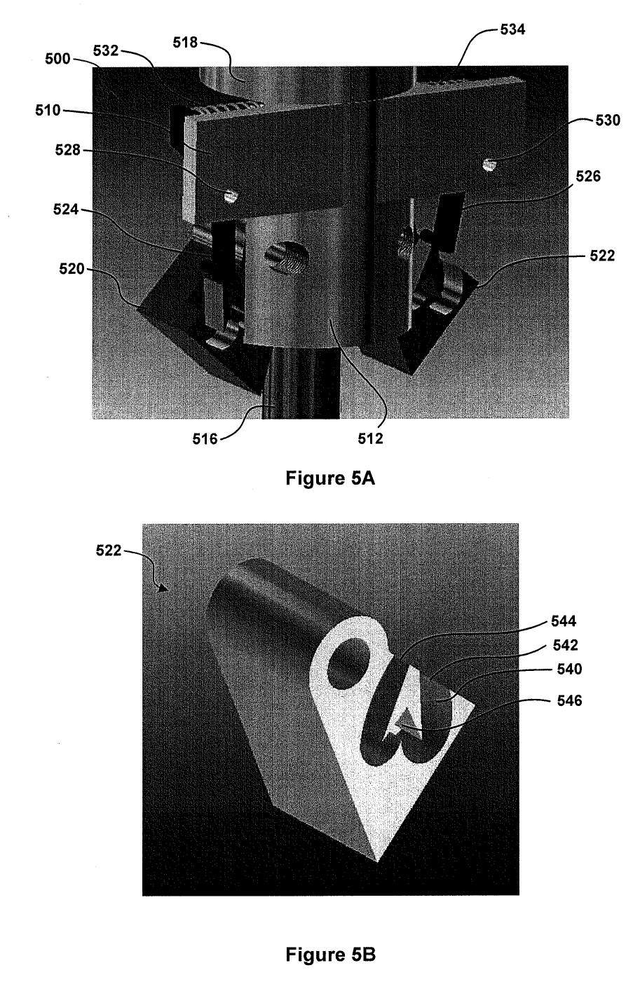

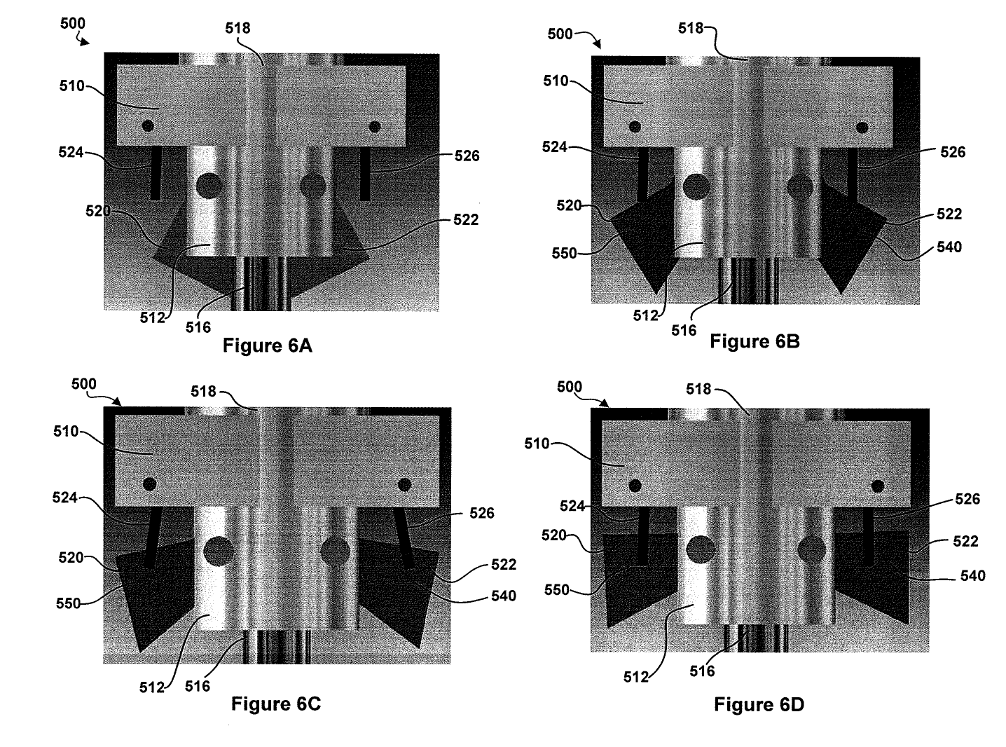

Another embodiment for a locking mechanism for a lock in use with a telescopic support element is illustrated in FIGS. 5A, 5B, 6A, 6B, 6C and 6D. In this embodiment, the telescopic support element is allowed to extend without restraint and then is locked in place when it is contracted. To unlock, the telescopic support element is first extended further, and then the telescopic support element is allowed to contract without restraint.

Turning to FIG. 5A, a perspective view of a locking mechanism 500 for a telescopic support element is shown. As with the previous embodiment, the locking mechanism is located within or integrated with a housing (not shown). The locking mechanism 500 includes a follower support member 510 and a cam support member 512; however, the members 510 and 512 may also be formed as part of the housing. A passageway is located along the central vertical axis of the housing to permit an inner section 516 of a telescopic support element to pass through the locking mechanism 500. A first cam 520 and a second cam 522 are pivotally mounted to the cam support member 512 such that the cams 520,522 can rotate towards and away from the inner section 516. The locking mechanism further includes a first cam follower 524 that is pivotally mounted to the follower support member 510 about pivot point 528 and a second cam follower 526 that is pivotally mounted to the follower support member 510 about pivot point 530. Springs 532 and 524 are positioned between the top of the cam followers 524, 526 and the cam support member 512. Thus, the cam followers 524, 526 are biased to be in parallel to the axis of travel of the inner section 516.

Turning to FIG. 5B, a perspective view of the second cam 522 is shown in greater detail. In the preferred embodiment, the features of the first cam 520 will mirror those of the second cam 522. The second cam 522 includes a channel 540 located on the inner lateral surface of the second cam 522. As can be seen, the channel is substantially in a ‘W’ shape. The entrance 542 and exit 544 of the ‘W’ shape are open to allow the second cam follower 526 to enter and exit the channel 540. The midpoint of the ‘W’ shape includes an indent 546 for the second cam follower 526 to stop at while traversing the channel 540. The first cam follower 524 operates in a similar manner with the first cam 520.

Turning to FIGS. 6A, 6B, 6C and 6D, operation of a locking mechanism 500 is shown. FIG. 6A illustrates a front view of the locking mechanism 500 in a locked position. The cams 520,522 have their inner surface in contact with the inner section 516. The cams 520,522 provide a normal force against the inner section 516 to produce enough forces of friction to prevent the inner section 516 from moving in the contracting direction relative to the outer section 518.

FIG. 6B illustrates a front view of the locking mechanism 500 in a first intermediate position between the locked position and an unlocked position. As the inner section 512 moves in a direction whereby the telescopic support element is extending, relative to the outer section 518, the cams 520,522 rotate due to friction. The first cam 520 rotates in the clockwise direction and the second cam 522 rotates in the counter-clockwise direction. As the first cam 520 rotates, the first cam follower 524 travels along the downwardly angled top surface of the first cam 520 until it enters the entrance to the channel 550. Similarly, as the second cam 522 rotates, the second cam follower 526 travels along the downwardly angled top surface of the second cam 522 until it enters the entrance to the channel 540.

FIG. 6C illustrates a front view of the locking mechanism 500 in a second intermediate position between the locked position and the unlocked position. The cam followers 524,526 follow the shape of the channels 550,540 as the cams 520,522 rotate due to the extending motion of the inner section 516.

FIG. 6D illustrates a front view of the locking mechanism 500 in the unlocked position. In the unlocked position, the cam followers 524,526 are situated in the indent 546 at the midpoint of the ‘W’ shape of the channels 550,540. When the locking mechanism 500 is in the unlocked position, the cams 520,522 a smaller portion of the cams 520,522 is in contact with the inner section 516 such that the forces of friction provided by the contact does not provide substantial restraint to the movement of the inner section 512 when is it extending away from the outer section 518. The positions of the cam followers 524,526 in the channels 550,540 also reduce the likelihood of or prevent the cams 520,522 from rotating any further than approximately 90 degrees. Thus, further extending of the telescopic support element from the locked position causes the cams 520,522 to move into the unlocked position; from the unlocked position, the inner section 516 is permitted to move in the contracting direction relative to the outer section 518.

When the inner section 516 is moved again in the extending direction relative to the outer section 518, the cam followers 524,526 begin to traverse the remaining portions of the channels 550,540. Due to friction with the inner section 516, the first cam 520 will rotate in the counter-clockwise direction and the second cam 522 will rotate in the clockwise direction. Afterward, when the inner section 516 is moved again in the contracting direction relative to the outer section 518, friction with the inner section 516 will cause rotation of the first cam 520 in the clockwise direction and the second cam 522 in the counter-clockwise direction allowing the cam followers 524,526 to exit the channels 550,540 at the exit point. Once the cam followers 524,526 exit the channels 550,540, the locking mechanism 500 will be in the locked position and the inner section 516 will be prevented from travelling in the contracting direction relative to the outer section 518.

In this embodiment, the locking mechanism 500 can be operated without having to place and remove the lock from the telescopic support element. In a specific example, the lock can be placed on or built into a telescopic support element for a hood of a car. A user can open the hood to gain access to the engine compartment. The user will stop opening the hood at the point when the hood provides enough access and the hood will lock in place. When the user wishes to close the hood again, the user will open the hood a little further and then lower the hood to close the engine compartment. This example shows the ease of use, convenience and safety provided by the lock of the disclosure.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A lock for a telescopic support element comprising:
a housing comprising a central passageway for receiving the telescopic support element;
a first cam mounted inside the housing adjacent the passageway; and
a second cam mounted inside the housing adjacent the passageway opposite the first cam;
wherein movement of the telescopic support element from a contracted position to an extended position within the central passageway causes the first cam and the second cam to rotate from an unlocked position to a locked position thereby locking the telescopic support element in place.

2. The lock of claim 1, wherein the first cam comprises a portion with a material with a high coefficient of friction for increasing friction between the first cam and the telescopic support element and the second cam comprises a portion with a material with a high coefficient of friction for increasing friction between the second cam and the telescopic support element.

3. The lock of claim 1, wherein the first portion comprises a first stopper for abutting the first cam in the unlocked position and the second portion comprises a second stopper for abutting the second cam in the unlocked position.

4. The lock of claim 1, wherein the first cam and the second cam are eccentrically shaped, the first cam being in the locked position when the portion of the first cam with a larger radius is substantially in contact with the telescopic support element and the second cam being in the locked position when the portion of the second cam with a larger radius is substantially in contact with the telescopic support element.

5. The lock of claim 1, the lock further comprising:
a first cam follower pivotally mounted inside the housing; and
a second cam follower pivotally mounted inside the housing,
wherein the first cam comprises a first channel configured to receive an end of the first cam follower and the second cam comprises a second channel configured to receive an end of the second cam follower.

6. The lock of claim 1, wherein the first channel and the second channel comprise a pattern configured such that movement of the telescopic support element from a contracted position to an extended position causes the first cam and the second cam to rotate from an unlocked position to a locked position, and movement of the telescopic support element to a further extended position causes the first cam and the second cam to rotate from the locked position to the unlocked position such that the telescopic support element is allowed to move to the contracted position.

7. The lock of claim 6, wherein the pattern is in a substantially ‘W’ shape.

8. The lock of claim 1, wherein the lock is integrally formed into a portion of the telescopic support element.

9. The lock of claim 1, wherein the housing comprises a first portion and a second portion.

10. The lock of claim 9, wherein the first cam is mounted in the first portion and the second cam is mounted in the second portion.
